(19) United States
(12) Patent Application Publication
(10) Pub. No.: US 2024/0257215 A1
(43) Pub. Date: Aug. 1, 2024

(54) SYSTEM AND METHOD FOR INTENT INFERENCE FROM SOCIAL ONLINE SHOPPING

(71) Applicant: Sarbjit S. PARHAR, Mississauga (CA)

(72) Inventor: Sarbjit S. PARHAR, Mississauga (CA)

(21) Appl. No.: 18/423,764

(22) Filed: Jan. 26, 2024

Related U.S. Application Data
(60) Provisional application No. 63/481,667, filed on Jan. 26, 2023.

(51) Int. Cl. G06Q 30/0601

(52) U.S. Cl. CPC G06Q 30/0631

(57) ABSTRACT

System and method for intent inference from social online shopping. The method includes: receiving from a first user device associated with a first user, an invitation request for social online shopping at a third-party online shopping platform; generating an invitation to one or more contacts identified in the invitation request; transmitting the invitation to the one or more contacts; in response to detecting acceptance of the invitation, connecting the first user device with the one or more second devices; receiving communication data between the first device and the one or more second devices; inferring an intent of the first user and the one or more contacts based on the communication data; and generating based on the intent a recommendation in association with one or more products or services provided by the third-party online shopping platform.

### CROSS-REFERENCE

This application claims priority from U.S. Provisional Patent Application No. 63/481,667, filed Jan. 26, 2023, entitled SOCIAL ONLINE SHOPPING AND EXPERIENCE, the contents of which are incorporated by reference into the DETAILED DESCRIPTION OF EXAMPLE EMBODIMENTS herein below.

### TECHNICAL FIELD

Some example embodiments relate to social online shopping, and in particular, to systems and methods for social online shopping and experience.

### BACKGROUND

Online shopping generally has a lower conversion rate and a higher return rate than physical brick and mortar store shopping. For example, the conversion rate of online shopping is 5 time lower than physical brick and mortar retail shopping conversion rate, and the return rate of online shopping is 3 time higher than physical brick and mortar retail return rate. For example, the online shopping conversion rate is 3% as compared to the brick & mortar retail conversion rate of 17%. This results in lost revenue opportunity for E-commerce. The online E-commerce return rate an average is 25% as compared to 8% for the brick and mortar shopping. This is not only a hassle for consumers but also results in higher cost. Both of these issues can be traced down to the differences in the customer experience. The online shopping experience is solitary as compared to the brick and mortar is social experience.

Although the social experience can be achieved via social platforms, this typically requires switching from an E-commerce website to a social platform. This tends to turn customers away due to the friction in the process.

### SUMMARY OF THE INVENTION

Examples of the system and method enable converting the solitary online shopping experience to a social shopping experience without leaving the E-commerce platform by allowing real-time discussion of the products and services available on the E-commerce platform between the users and their contacts, such as family members and/or friends.

As well, the system and method can use artificial intelligence (AI), based on the conversations among users and their contacts during social online shopping, to recommend products or services, to bundle products and/or services, to offer quantity discounts to users, and to offer curated experiences to the users.

The system and method can also be used by the non-E-commerce companies, including brand organizations or regular companies for internal use for connecting employees with their customers. For example, the system and method allow non-E-commerce platforms to connect with their customers by answering their questions, which can be critical to the success of the non-E-commerce platforms.

An example embodiment is a method for intent inference from social online shopping, comprising: receiving, at a processor, from a first user device associated with a first user, an invitation request for social online shopping at a third-party online shopping platform; generating, at the processor, an invitation to one or more contacts identified in the invitation request; transmitting the invitation to the one or more contacts; in response to detecting acceptance of the invitation by one or more second user devices associated with the one or more contacts, connecting the first user device with the one or more second user devices; receiving, at the processor, communication data between the first user device and the one or more second user devices; inferring, at the processor, an intent of the first user and the one or more contacts based on the communication data; and generating based on the intent, by the processor, a recommendation in association with one or more products or services provided by the third-party online shopping platform.

In another example embodiment of any one of the preceding methods, the invitation request comprises an address of a third-party webpage of the third-party online shopping platform.

In another example embodiment of any one of the preceding methods, the invitation request comprises inviting the one or more second user devices to share a screen of the first user device.

In another example embodiment of any one of the preceding methods, the invitation request comprises an address of a third-party webpage of the third-party online shopping platform, and screen width and height of the first user device, first webpage view settings of the first web browser window that is displaying the third-party webpage, the first webpage view settings comprising width and height of the first web browser window that is displaying the third-party webpage, and first scroll X and Y positions of the first web browser window that is displaying the third-party webpage on the first user device.

In another example embodiment of any one of the preceding methods, in response to detecting acceptance of the invitation by the one or more second user devices associated with the one or more contacts, receiving, at the processor, from each of the one or more second user devices, second screen width and height of the each of the one or more second devices, and width and height of the second web browser window; and transmitting, from the processor, to each of the one or more second devices, respective codes that allow the one or more second user devices to display the third-party webpage on a second web browser window of each of the one or more second user devices, and second webpage view settings, comprising second scroll X and Y positions of the second web browser window, to effect a same relative webpage view setting on each of the one or more second user devices as the first webpage view settings of the first web browser window that is displaying the third-party webpage on the first user device.

In another example embodiment of any one of the preceding methods, the inferring is further based on content of the screen of the first user device that is or was shared.

In another example embodiment of any one of the preceding methods, the invitation comprises a Uniform Resource Locator (URL) link.

In another example embodiment of any one of the preceding methods, the recommendation comprises alternative products or services.

In another example embodiment of any one of the preceding methods, the recommendation comprises bundled products or services in addition to a product or service interested by the first user and the one or more contacts.

In another example embodiment of any one of the preceding methods, the recommendation comprises quantity discount information of the one or more products or services to the first user and the one or more contacts.

In another example embodiment of any one of the preceding methods, the method further includes generating, by the processor, the recommendation using one or more machine learning models.

In another example embodiment of any one of the preceding methods, the third-party online shopping platform is a third-party host server to the processor.

In another example embodiment of any one of the preceding methods, the processor receives the communication data by using WebRTC (Web Real-Time Communication).

In another example embodiment of any one of the preceding methods, the communication data relates to one or more products or services.

In another example embodiment of any one of the preceding methods, the communication data comprises one or more of texts, speeches, images, or video.

In another example embodiment of any one of the preceding methods, the communication data comprises audio data, and the processor is configured to convert the audio data to text for the inferring.

In another example embodiment of any one of the preceding methods, the communication data is stored in a cloud server.

In another example embodiment of any one of the preceding methods, the processor is in a cloud server.

In another example embodiment of any one of the preceding methods, the method further includes receiving, at the processor, two or more payments for a product or a service from two or more of the first user and the one or more second users, wherein a total amount of the two or more payments equals to a price of the product or the service, and wherein the each of the two of more payments is associated with the product or the service and the first user and the one or more second users.

In any one of the preceding embodiments, receiving a refund request from one or more of the first user device and the one or more second user devices; and refunding the two or more payments to the two or more of the first user and the one or more second users.

A system for intent inference from social online shopping, comprising: a server having at least one processor configured to perform the method according to any one of the preceding embodiments.

### BRIEF DESCRIPTION OF THE DRAWINGS

Reference will now be made, by way of example, to the accompanying drawings which show example embodiments, and in which:

FIG. 1 is a schematic diagram of a system for social online shopping, according to an example embodiment;

FIG. 2 is another diagram showing an exemplary operation of the system in FIG. 1;

FIG. 3 is a flow chart illustrating a social online shopping process, according to an example embodiment;

FIG. 4 is a diagram illustrating an exemplary webpage and interface of the system in FIG. 1, according to an example embodiment;

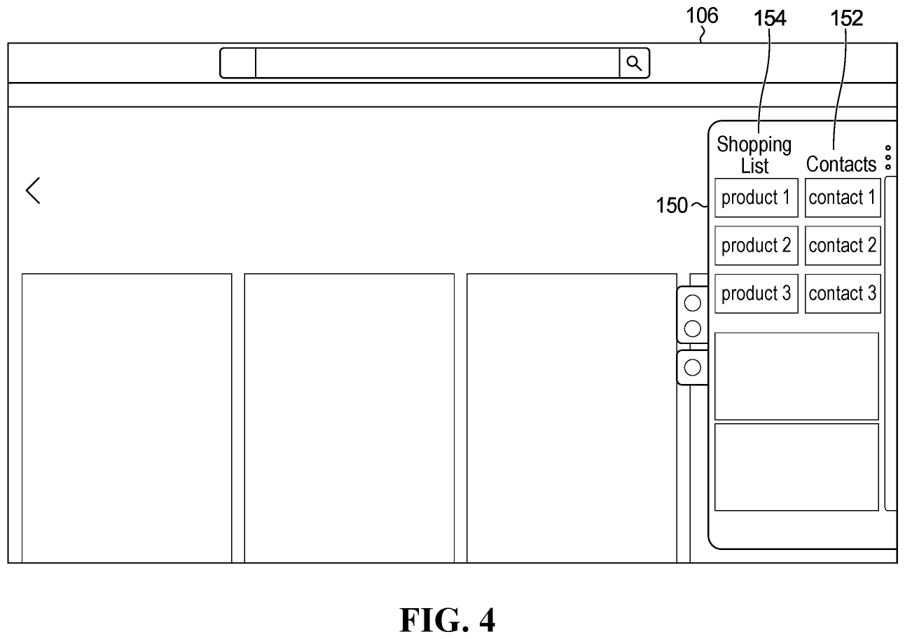

FIG. 5 is a diagram illustrating another exemplary webpage and interface of the system in FIG. 1, according to another example embodiment;

FIG. 6 is a diagram showing another example of the system in FIG. 1, according to another example embodiment; and

FIG. 7 is a block diagram of a server in FIG. 1, according to an example embodiment.

### DETAILED DESCRIPTION OF EXAMPLE EMBODIMENTS

In examples, the term “web browser window” of a webpage can also refer to web windows, headless web windows, or web browser tabs within a web browser program. In all examples herein, any reference to operation by a “person”, “user” or “customer” similarly applies to a function or operation of a “device” being used by that person, user or customer.

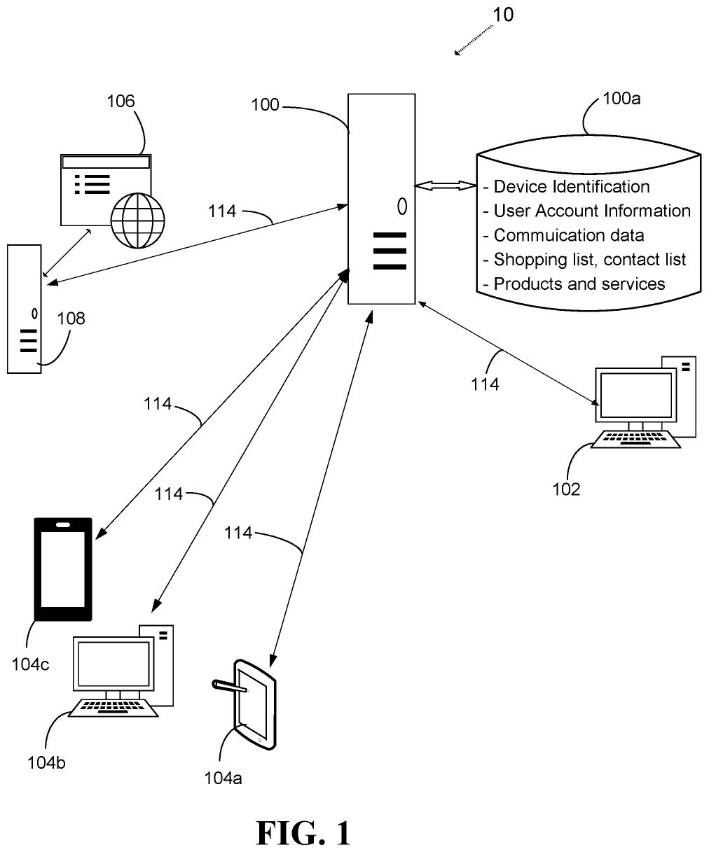

FIG. 1 illustrates a system 10 for social online shopping, according to an example embodiment. The system 10 may include a server 100, a database 100a, two or more user devices 102 and 104a-104c.

The server 100 is configured to communicates with the two or more user devices 102 and 104a-104c, and the database 100a. The user devices 102 and 104a-104c may be any communication devices, such as computers, tablets, or smart phones. The server 100 can communicate with the user devices 102 and 104a-104c via the communication link 114. The communication link 114 may be provided by one or more communication networks, such as a wireless network, and/or a wired communication network.

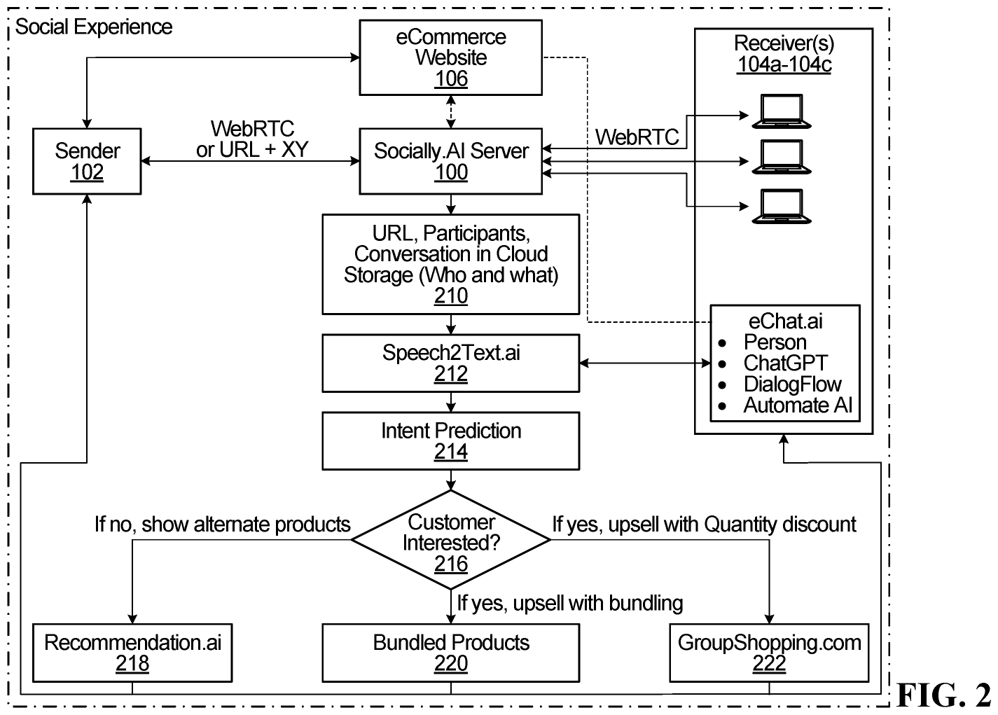

In the example of FIGS. 1 and 2, the user devices 102 and 104a-104c communicate with each other via the server 100. Each of the user devices 102 and 104a-104c supports two-way audio, video and text data communications. Each of the user devices 102 and 104a-104c may include one or more speakers, microphones, cameras, and the text input devices, such as keyboards.

The server 100 is configured to receive the communication data from between, the users. In the example of FIG. 2, the server 100 is configured to receive all the communication data from one or more senders, which may be one or more of user devices 102 and 104a-104c, and relay the communication data to one or more receiver, which may be one or more of user devices 102 and 104a-104c.

As illustrated in the example of FIG. 2, the server 100 may use WebRTC (Web Real-Time Communication) to receive the communication data exchanged between the users. WebRTC provides web browsers and mobile applications with real-time communication (RTC) via application programming interfaces (APIs), and allows direct peer-to-peer communication in text, audio, and video communications inside webpages, including a third-party webpage 106. The server 100 may also use an inline frame (iFrame) to retrieve information on the webpage 106. iFrame is a HTML element that loads another HTML page within the parent webpage.

In some examples, the server 100 can be a cloud server. The system 10 in this case is a cloud platform.

The database 100a can be integrated in the server 100, or provided in a separate server. In some examples, the database 100a is a remote or cloud database.

The database 100a is configured to stores user account information, device identification of the user devices 102 and 104a-104c, communication data, shopping list and contact list of a user, and products and services of a third-party server 108. The account information includes information uniquely identify a registered user in system 10, such as name, address, contact information of the user. The account information may also include necessary financial information for one or more users to complete online shopping financial transactions, such as credit card information, PayPal™ information, or information of any other online payment options. The server 100 uniquely identify a user when the user logs into the server 100.

After a user logged into the system 10, the account information of the user is associated with respective user device 102 or 104a-104c, and thus associated with the device identification of the user devices 102 and 104a-104c. The server 100 uniquely identifies a device of the specific end customer 314 or 316, which will be described in great detail below.

In one household, however, there may be more than one device with the same IP address, and IP address may be changed from time to time. The medium access control (MAC) address of a device is also impractical, as it is not publicly available due to the security concerns. Instead, in some examples, the server 100 identifies the image of the browser settings from each device. Each web browser such as Microsoft Internet Explorer™ or Google Chrome™ associated with or installed in a device has a unique image of browser settings. When a device first visits a website registered with server 100, the server 100 generates saves the image of browser settings of the devices in database 100a. In each subsequent visit of the registered websites with server 100 by the device, server 100 compares the image of browser settings of the device with the saved image of browser settings in database 100a. If server 100 finds a match, server 100 identifies the device with the image of browser settings, and thus identifies the user associated with the device.

The device identification of the user devices 102 and 104a-104c uniquely identifies each of the user devices 102 and 104a-104c signed in the server 100, by identifying a Device ID based on, for example, image of browser settings and/or IP address of the device and/or User Agent data of the user devices 102 and 104a-104c.

The browser fingerprint of the user devices 102 and 104a-104c can be determined by the server 100 using the JavaScript™ function “Fingerprintjs2”, which is a unique JavaScript™ fingerprint of the browser settings of the user device in the form of a hexadecimal sequence, as understood in the art. The User Agent data of the user device is determined by the server 100 from a HTTP request header received from the user interface 150, and which includes the application type, operating system, software vendor or software version of the user device. In an example, the Device ID can be generated by aggregating this combination, optionally along with other computations (e.g. hashing). In various examples, one, two or three of the three parameters of the combination are used to generate the Device ID.

In some examples, the server 100 may identify the device with a Device ID which includes the image of the browser settings and the IP address used by the device and the User Agent data of the device.

The communication data stored in the database 100a may include audio signals from the users via the user devices 102 and 104a-104c, such as speech of the users using the user devices 102 and 104a-104c, and/or text or voice messages, or image files exchanged among the users via the user devices 102 and 104a-104c. The communication data may include information on the webpage 106, conversations or discussions between the users and contacts, feedback on products or services, etc. The communication data may also include images, or videos that are used during the communications between the users.

In an example, the communication data from the video can include the audio data from the video. In an example, the audio data is converted to text using speech-to-text for inferring the context of the text.

In an example, sentiment data is extracted from the video, for example one or more of the users on the conversation.

In an example, product or service data is extracted from the video, for example one or more of the users on the conversation may be displaying an actual product or demonstrating a service on the video. For example, one or more users may be displaying a color of a desired product for discussion.

The database 100a may also store one or more shopping lists, which include lists of the goods or services in which one or more users are interested, and one or more contact lists, which include the contacts of each user, such as email addresses, telephone numbers, and social media accounts of the contacts.

In the example of FIGS. 1 and 2, the user devices 102 and 104a-104c are configured to browse a third-party webpage 106 hosted by a third-party server 108 via the Internet. The third-party server 108 may be one or more online shopping platforms or an E-commerce platform, such as eBay™, Amazon™, or other E-commerce websites supporting online shopping. The server 100 is configured to communicate with the third-party server 108 via a communication link 114. For example, the server 100 may retrieve information of available products or services, available product bundles, available volume discount from the third-party server 108, and provide this information to the users associated with the user devices 102 and 104a-104c.

As will be described in greater detail later, based on the communication data collected, the server 100 is configured to provide a recommendation related to products or services to users. For example, the server 100 can use an intent prediction machine learning model, for example using convolutional neural network (CNN) based model, to predict the intent of users and make recommendations on products or services for online shopping.

For example, a machine learning model can be implemented by a neural network running in the server 100. Neural networks will be briefly described in general terms. A neural network can include multiple layers of neurons, each neuron receiving inputs from a previous layer, applying a set of weights to the inputs, and combining these weighted inputs to generate an output, which can in turn be provided as input to one or more neurons of a subsequent layer.

A layer of neurons uses filters to define the relationship between the outputs of the neurons of the previous layer and the outputs of the neurons of the current layer. A layer of the neural network receives a data input, usually in the form of a data array of known dimensions. By applying the set of filters (layers) to the data input, such as the communication data input, each layer generates a data output, which is typically a data array having known dimensions. A filter comprises a set of weights (also called parameters).

The machine learning model is trained to infer the intent of the users based on the communication data input. In the example of a neural network, training a neural network involves learning or determining the appropriate weight values at different weight locations throughout the network. After being optimally trained to perform a given inference task, the weights of the neural network will not all contribute equally to the final inference outputs: some weights will have high value due to their high contribution, while other weights will have low value due to their low contribution. If the weights are not properly trained (e.g., high value weights are misplaced or miscalibrated by training), then the trained network will perform with less accuracy. In identifying the intent of a user, the machine learning model can be trained by a suitable set of training data to determine appropriate weights. The training data may include a labeled set of inputs that can be based on simulated or actual scenarios. The trained machine learning model can be used to create and apply models for performing the inference tasks. In some examples, the trained machine learning model includes a support vector machine (SVM) or linear regression.

The trained machine learning model can be used to create and apply models for performing intent inference tasks, such as identifying the intent of users based on the communication data.

The machine learning model in the server 100 can generate recommendations on products or services based on the intent of the users, and the server 100 can send the recommendation to the user devices 102 and 104a-104c via the communication link 114.

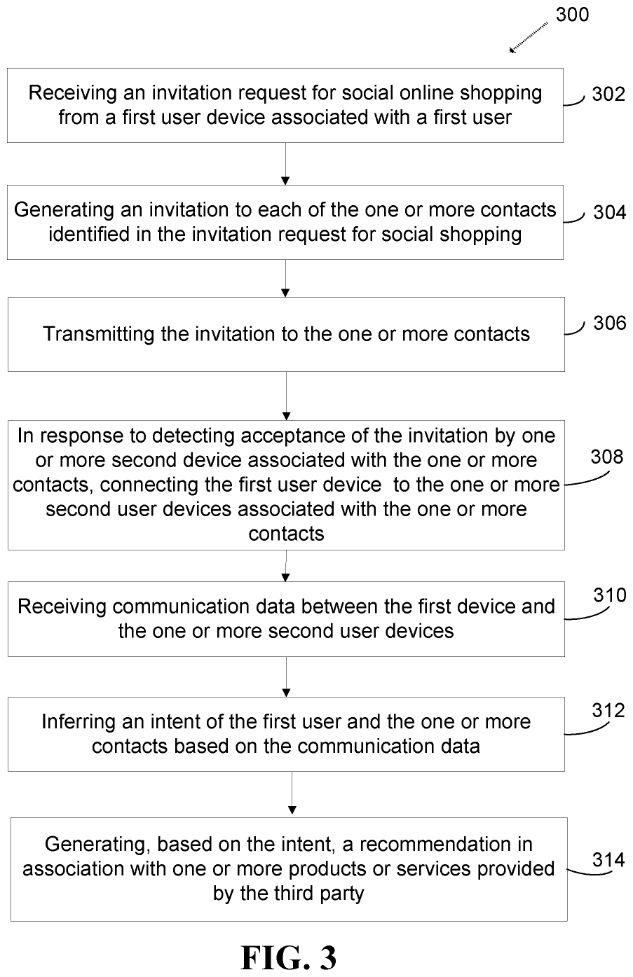

FIG. 3 illustrates an example of social online shopping process 300 using the system 10, in accordance with example embodiments.

In FIG. 3, a first user signs in to the server 100 using the first device 102. The server 100 may uniquely identify the first user and the first device 102 using the user account information and device identification stored in the database 100a. A first user may use the first user device 102 visits an E-commerce webpage 106 hosted by the server 108, such as Amazon™. When the first user opens a webpage 106, the server 100 is configured to embed on the webpage a user interface or front end 150 of server 100. The user interface 150 allows the server 100 to access the contact list 152 of the first user on the user device 102. The contact list 152 may include names, phone numbers, email addresses of the first user's contacts, or other contact information of the first user's contacts that allows the first user to contact the selected contacts, such as social media identification information of the contacts. The user interface 150 may be an application, such as AI application, supported by the server 100 for social online shopping.

The first user using the first user device 102 may browse the products or services displayed on the webpages 106 hosted by the third-party server 108. If the first user is interested in one or more products or services, the first user may add the products or services to the shopping list 152. The shopping list 152 may include webpage links directed to the third-party server 108. The webpage links include the information of the products or services of the first user's interest.

The server 100 may save the contact list 152 and the shopping list 154 of the first user in database 100a.

The first user may initiate a social online shopping using the first user device 102. For example, the first user may select one or more contacts from the contact list 152 on the user interface 150 displayed on the first user device 102, and then send to the server 100 an invitation request to the selected contacts via the first user device 102. The invitation request identifies one or more contacts selected by the first user for social online shopping at the third-party host server 108, which may be one or more third-party online shopping platforms, and includes an address of the third-party webpage 106 from the third-party host server 108. The invitation request also contains the products and services that the first user would like to invite the one or more contacts for social online shopping at the third-party host server 108.

In some examples, the first user may share the screen on the first user device 102 with the one or more contacts. In this regard, in addition to the address of the third-party webpage 106, the invitation request may additionally include screen sharing data including: screen width and height of the first user device 102, first webpage view settings of the first web browser window that is displaying the third-party webpage 106. The first webpage view settings comprises width and height of the first web browser window that is displaying the third-party webpage 106, and first scroll X and Y positions of the first web browser window that is displaying the third-party webpage 106, as illustrated in FIG. 2.

At step 302, the server 100 receives, from the first user device 102 associated with the first user, the invitation request for social online shopping at the third-party online shopping platform.

In the example that, in the invitation request, the first user shares the screen on the first user device 102 with the one or more contacts, based on the screen sharing data, the server 100 is configured to retrieve the web page width and height of the third-party webpage 106 from the third-party host server 108.

At step 304, the server 100 generates an invitation to each of the one or more contacts identified in the invitation request. The invention may contain a Uniform Resource Locator (URL) link. The URL link may address the third-party host server 108 or if the first user shares the screen with the one or more contacts, the URL link addresses the server 100.

At step 306, the server 100 transmits the invitation to the one or more contacts. The invention to each contact may be contained in an email, or a message.

After the one or more contacts associated with the second user devices 104a-104c receives the invitation, the one or more contacts may accept the invitation by clicking on the URL link in the invitation displayed on the second user devices 104a-104c. By clicking on the URL link, the second user devices 104a-104c are directed to the third-party host server 108, so that the same third-party webpage 106 is displayed on the second user devices 104a-104c and the first user device 102.

If the first user shares the screen on the first user device 102 with the one or more contacts, after the one or more contacts associated with the second user devices 104a-104c accept the invitation, the server 100 is configured to receive, from each of the one or more second user devices 104a-104c, second screen width and height of the each of the one or more second user devices 104a-104c, and width and height of the second web browser window of the each of the one or more second user devices 104a-104c, and to transmit, to each of the one or more second user devices 104a-104c, respective codes that allow the second user devices 104a-104c to display the third-party webpage 106 on a second web browser window of each of the one or more second devices 104a-104c, and second webpage view settings comprising second scroll X and Y positions of the second web browser window, to effect a same relative webpage view setting on the second user devices 104a-104c as the first webpage view settings of the first web browser window that is displaying the third-party webpage 106 on the first device 102. As such, the third-party webpage 106 on the first device 102 is also displayed on the second user devices 104a-104c.

At step 308, after the server 100 detects acceptance of the invitation by one or more second user devices 104a-104c associated with the one or more contacts, the server 100 is configured to connect at the server 100 the first user device 102 associated with the first user with the second user devices 104a-104c associated with the one or more contacts, so that the first user device 102 can communicate with the second user devices 104a-104c via the server 100.

At step 310, the server 100 receives communication data between the first user device 102 and the second user devices 104a-104c. The communication data may include real-time discussion about relevant produces or services among the first user via the first user device 102 and the contacts via the second user devices 104a-104c in audio and/or video signals, or text messages. As illustrated in FIG. 2, at step 210, the server 100 may save the URL link, first user and one or more contacts information, and communication data to the database 100a, which may be a cloud-based database.

As well, if a contact is not able to join the discussion at the scheduled time of invitation, the contact may provide comments at a later time to the first user in text, speech, image, or video at the server 100. The comments may also include comments entered into a text box during the conversation. The server 100 may also include the comments as part of the communication data.

At step 312, the server 100 is configured to infer an intent of the first user and the one or more contacts based on the communication data. As illustrated in the example of FIG. 2, if the communication data includes audio signals or speech, at step 212, the server 100 may use the Speech-to-Text AI applications to convert the audio signals or the speech to text. At step 214 in the example of FIG. 2, the server 100 may use the text converted from the speech to infer the intent of the first user and the one or more contacts. The server 100 may use an intent prediction machine learning model to infer the intent of the first user and the one or more contacts. The intent prediction machine learning model may be trained to infer an intent based on one or more selected training datasets.

In an example, the inference at step 312 is also based on content on the third-party webpage 106 on the shared screen, e.g. what is or was displayed on the third-party webpage 106 on the shared screen. Therefore, in an example embodiment, the inferring at step 312 is further based on content of the screen of the first user device 102 that is or was shared.

The inferred intent indicates whether the first user and the one or more contacts are interested in the one or more products or services displayed in the third-party webpage 106. Other related or similar products or services can be inferred from the third-party webpage 106 may not necessarily be the products or services that are actually displayed in the third-party webpage 106. For example, a displayed product or service from one brand can infer the product or service from another brand. For example, a displayed first product or service can infer a related second product or service that can be used with the first product or service, e.g. a conversation related to the product of skis that is displayed on a shared screen of the first user device can infer one or more other related products such as ski poles, winter clothes, ski boots.

At step 314, the server 100 is configured to generate, based on the intent, a recommendation in association with one or more products or services provided by the third-party server 108, which may be an online shopping platform. The server 100 may generate the recommendation using AI machine learning models. In the example of FIG. 2, based on the inferred intent from step 214, at step 216, the server 100 determines whether the first user and the one or more contacts are interested in the one or more products or services displayed in the third-party webpage 106.

The server 100 is configured to recognize the products or services displayed or described on the webpage 106 using AI machine learning models.

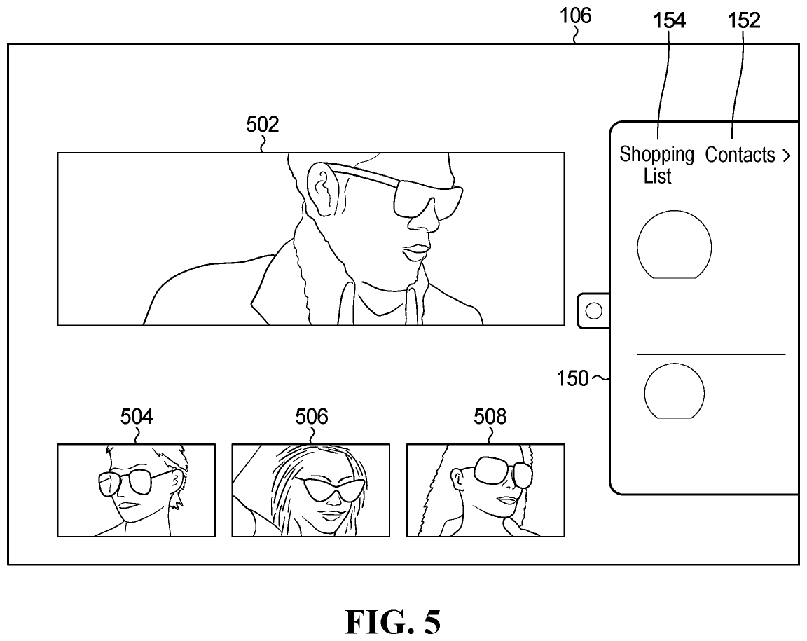

If the first user and the one or more contacts are not interested in the products or services provided in the webpage 106, at step 218, the server 100 may generate a recommendation containing alternative products or services. For example, if the first user and the one or more contacts are not interested in product 502 in FIG. 5, the server 100 may recommend alternative products 504, 506, or 508. The alternative products or services may be based on the products or services available on the third-party host server 108. The third-party host server 108 may include one or more online shopping platforms, such as eBay™, and/or Amazon™.

If the first user and the one or more contacts are interested in the one or more products or services, such as product 502 in FIG. 5, at step 220, the server 100 may generate, such as by using a machine learning model recommendation.ai, a recommendation containing bundled products or services to the first user and the one or more contacts. For example, the server 100 may bundle additional products 504, 506, and/or 508 with product 502 that is interested by the first user and the one or more contacts. The server 100 may bundle products or services using Association Rule Machine Learning Models, Clustering Machine Learning Model, and/or Recommender System Machine Learning Model. Alternatively, if the first user and the one or more contacts are interested in the one or more products or services, such as product 502 in FIG. 5 at step 222, the server 100 may generate a recommendation containing quantity discount information of the one or more products or services to the first user and the one or more contacts, such as in form of timely coupons, such as quantity discount information of the product 502.

As such, the system 10 may increase sales for the products or services of the third-party online shopping platform hosted by the server 108, promote brand and customer satisfaction, reduce prices for the consumers, and increase the use of the third-party online shopping platform. By generating recommendations based on the intent of the users, the system 10 offers targeted recommendations of products and services to improve the conversion rate.

As well, the system 10 integrates social and shopping experience of users in a single platform. By allowing real-time communication between the first user and the contacts, the system 10 converts solitary online shopping experience to a social experience without leaving the third-party online shopping platform.

The system 10 may also be used by non-E-commerce companies for connecting the companies with their customers to improve customer communication and services. Using the communication data between the customers and their contacts, the server 100 may similarly infer the intent of the customers and their contacts, and allow the non-E-commerce companies to connect with the customers, such as by using chatbots or human customer service representatives, to answer their questions including in products, services or stock information of the products. The chatbots can be manned by humans or powered by a custom GPT Generative Pre-Training Transformer.

In some examples, when the first user and/or the one or more contacts together proceed to purchase a product or service, if any one of the one or more contacts have not been registered with the server 100, to qualify as a payor in system 10, the server 100 registers the contact. The server 100 is configured to uniquely identify each payor registered in the server 100. After all the first user and the one or more contacts are registered in the server 100 as payors, the server 100 is configured to accept two or more payments for the product or service from two or more payors. The total of the two or more payments equal to the price of the product or the service. Each of the two of more payments is associated with a unique identification of the respective payors in the server 100, including the account information of the payors including first user and/or the one or more contacts in the server 100, the respective amount paid by the payors, the time of payments, and the product or service purchased.

In some examples, when any one of the two or more payors requests a refund for a product or service purchased, the server 100 receives a refund request for the product or service from the first user device 102 or second user devices 104a-104c associated with the payor. Based on the unique identification of the respective payors, the server 100 is configured to refund the respective payors the amount paid by the respective payors for the product or service. After refunding the respective payments, the server 100 is configured to update the unique identification of the respective payors in the server 100 to include the refunded amount, the time of refund, and the product or service refunded.

While the system 10 is described using the example of E-commerce platform, the system 10 may be used for any cloud hosted or internal websites/applications.

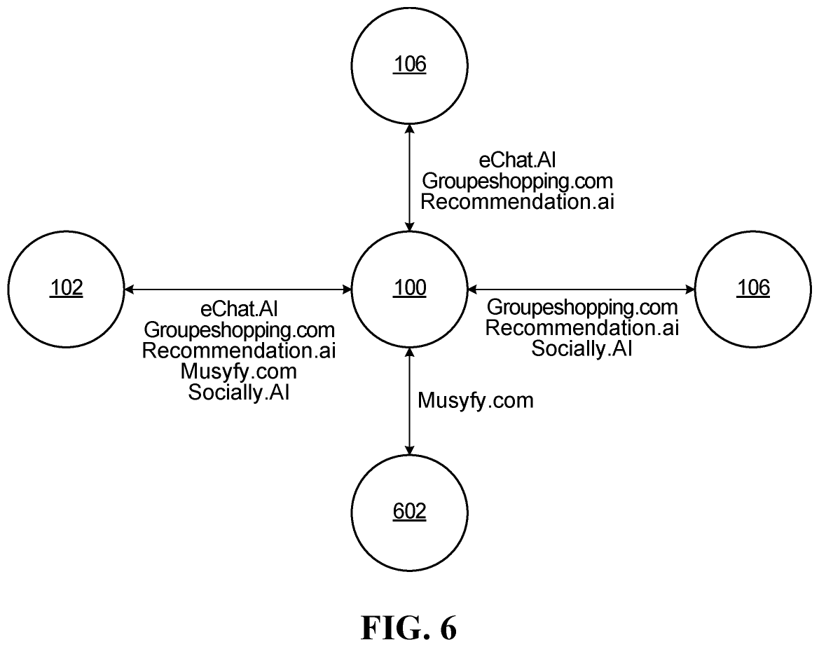

In some examples, as illustrated in the example of FIG. 6, the server 100 may be configured to cause the user interface 150 to seamless play music or personalized media 602 during the social online shopping of the first user or one or more contacts. Seamless playing music or personalized media is disclosed in U.S. patent Ser. No. 10/878,170 B2, which is incorporated by reference in its entirety.

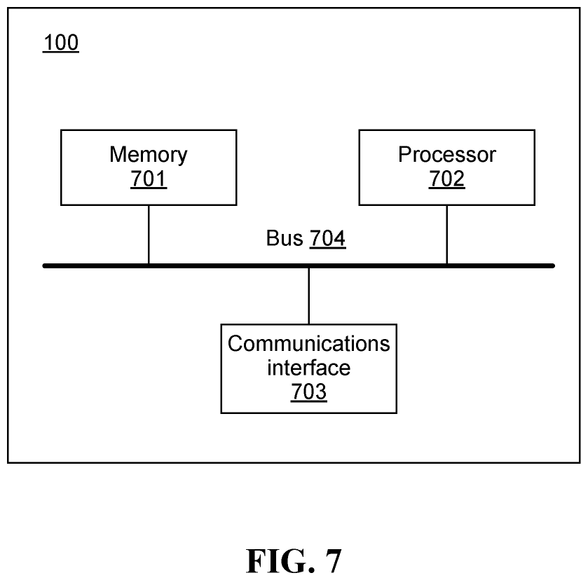

FIG. 7 is a schematic diagram of a hardware structure of the server 100 according to an example embodiment. The server 100 shown in FIG. 7 includes a memory 701, a processor 702, a communications interface 703, and a bus 704. A communication connection is implemented between the memory 701, the processor 702, and the communications interface 703 by using the bus 704.

The processor 702 and the communications interface 703 are configured to perform, when the program stored in the memory 701 is executed by the processor 702, steps of method 300.

The memory 701 can be a read-only memory (Read Only Memory, ROM), a static storage device, a dynamic storage device, or a random access memory (Random Access Memory, RAM). The memory 701 may store a program. The memory 701 can be a non-transitory memory.

The processor 702 can be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits.

In addition, the processor 702 may be an integrated circuit chip with a signal processing capability. In an implementation process, steps of method 300 can be performed by an integrated logical circuit in a form of hardware or by an instruction in a form of software in the processor 702. In addition, the processor 702 can be a general purpose processor, a digital signal processor (Digital Signal Processor, DSP), an application-specific integrated circuit (ASIC), a field programmable gate array (Field Programmable Gate Array, FPGA) or another programmable logic device, a discrete gate or a transistor logic device, or a discrete hardware assembly. The processor 702 can implement or execute the methods, steps, and logical block diagrams that are disclosed in the example embodiments. The general purpose processor can be a microprocessor, or the processor may be any conventional processor or the like. The steps of the method disclosed with reference to the embodiments may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 701. The processor 702 reads information from the memory 701, and completes, by using hardware in the processor 702, the steps of method 300.

The communications interface 703 implements communication between server 100 and another device or communications network by using a transceiver apparatus, for example, including but not limited to a transceiver. For example, the training data may be obtained by using the communications interface 703.

The bus 704 may include a path that transfers information between all the components of the server 100.

It should be noted that, although only the memory, the processor, and the communications interface are shown in the server 100 in FIG. 6, in a specific implementation process, a person skilled in the art should understand that the server 100 may further include other components that are necessary for implementing normal running. In addition, based on specific needs, a person skilled in the art should understand that the server 100 may further include hardware components that implement other additional functions. In addition, a person skilled in the art should understand that the server 100 may include only a component required for implementing the embodiments of the present invention, without a need to include all the components shown in FIG. 6.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several of the example embodiments described herein, it should be understood that the disclosed system and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a non-transitory computer-readable storage medium. Based on such an understanding, the technical solutions of the example embodiments essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the example embodiments. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

It will be understood that the devices described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of example embodiments. Variations of the innovations described herein will be apparent to persons of ordinary skill in the art, such variations being within the intended scope of the example embodiments. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the example embodiments as a whole. The subject matter described herein intends to cover all suitable changes in technology.

Certain adaptations and modifications of the described embodiments can be made. Therefore, the above discussed embodiments are considered to be illustrative and not restrictive.

What is claimed is:

1. A method for intent inference from social online shopping, comprising:
receiving, at a processor, from a first user device associated with a first user, an invitation request for social online shopping at a third-party online shopping platform;
generating, at the processor, an invitation to one or more contacts identified in the invitation request;
transmitting the invitation to the one or more contacts;
in response to detecting acceptance of the invitation by one or more second user devices associated with the one or more contacts, connecting the first user device with the one or more second user devices;
receiving, at the processor, communication data between the first user device and the one or more second user devices;
inferring, at the processor, an intent of the first user and the one or more contacts based on the communication data; and
generating based on the intent, by the processor, a recommendation in association with one or more products or services provided by the third-party online shopping platform.

2. The method of claim 1, wherein the invitation request comprises an address of a third-party webpage of the third-party online shopping platform.

3. The method of claim 1, wherein the invitation request comprises inviting the one or more second user devices to share a screen of the first user device.

4. The method of claim 3, wherein the invitation request comprises an address of a third-party webpage of the third-party online shopping platform, and screen width and height of the first user device, first webpage view settings of the first web browser window that is displaying the third-party webpage, the first webpage view settings comprising width and height of the first web browser window that is displaying the third-party webpage, and first scroll X and Y positions of the first web browser window that is displaying the third-party webpage on the first user device.

5. The method of claim 4, further comprising, in response to detecting acceptance of the invitation by the one or more second user devices associated with the one or more contacts, receiving, at the processor, from each of the one or more second user devices, second screen width and height of the each of the one or more second devices, and width and height of the second web browser window; and
transmitting, from the processor, to each of the one or more second devices, respective codes that allow the one or more second user devices to display the third-party webpage on a second web browser window of each of the one or more second user devices, and second webpage view settings, comprising second scroll X and Y positions of the second web browser window, to effect a same relative webpage view setting on each of the one or more second user devices as the first webpage view settings of the first web browser window that is displaying the third-party webpage on the first user device.

6. The method of claim 3, wherein the inferring is further based on content of the screen of the first user device that is or was shared.

7. The method of claim 1, wherein the invitation comprises a Uniform Resource Locator (URL) link.

8. The method of claim 1, wherein the recommendation comprises alternative products or services.

9. The method of claim 1, wherein the recommendation comprises bundled products or services in addition to a product or service interested by the first user and the one or more contacts.

10. The method of claim 1, wherein the recommendation comprises quantity discount information of the one or more products or services to the first user and the one or more contacts.

11. The method of claim 1, further comprising generating, by the processor, the recommendation using one or more machine learning models.

12. The method of claim 1, wherein the third-party online shopping platform is a third-party host server to the processor.

13. The method of claim 1, wherein the processor receives the communication data by using WebRTC (Web Real-Time Communication).

14. The method of claim 1, wherein the communication data relates to one or more products or services.

15. The method of claim 1, wherein the communication data comprises one or more of texts, speeches, images, or video.

16. The method of claim 1, wherein the communication data comprises audio data, and the processor is configured to convert the audio data to text for the inferring.

17. The method of claim 1, wherein the processor is in a cloud server.

18. The method of claim 1, further comprising:
receiving, at the processor, two or more payments for a product or a service from two or more of the first user and the one or more second users, wherein a total amount of the two or more payments equals to a price of the product or the service, and wherein the each of the two of more payments is associated with the product or the service and the first user and the one or more second users.

19. The method of claim 18, further comprising:
receiving a refund request from one or more of the first user device and the one or more second user devices; and
refunding the two or more payments to the two or more of the first user and the one or more second users.

20. A system for intent inference from social online shopping, comprising:
a server having at least one processor configured to perform the method according to claim 1.

21. A non-transitory computer-readable medium including program instructions stored thereon which, when executed by a processor, causes the processor to perform the method as claimed in claim 1.
